(19) United States
(12) Patent Application Publication
(10) Pub. No.: US 2023/0258220 A1
(43) Pub. Date: Aug. 17, 2023

(54) FASTENING APPARATUS AS WELL AS A FASTENING SYSTEM FOR FASTENING A COMPONENT TO A BOLT OF A CARRIER COMPONENT

(71) Applicant: ILLINOIS TOOL WORKS INC., Glenview, IL (US)

(72) Inventors: Christian PFEIFFER, Enkenbach (DE); Thiemo AMMANN, Rockenhausen (DE)

(21) Appl. No.: 18/107,382

(22) Filed: Feb. 8, 2023

(30) Foreign Application Priority Data
Feb. 11, 2022 (DE) 10 2022 103 234.5
Jan. 20, 2023 (DE) 10 2023 101 414.5

(51) Int. Cl. F16B 37/08

(52) U.S. Cl. CPC F16B 37/0857

(57) ABSTRACT

A fastening apparatus is provided for fastening a component to a bolt of a carrier component. The fastening apparatus includes a housing device having a receiving space for receiving a bolt in an axial direction and a fastening clip arranged in the receiving space of the housing device, wherein the fastening clip includes at least two, preferably spring-like latching arms, at whose free ends preferably linear latching edges are formed so as to hold a bolt, wherein the latching edges of the latching arms are inclined relative to the axial direction.

### TECHNICAL FIELD

The present invention relates to a fastening apparatus as well as a fastening system for fastening a component to a bolt of a carrier component.

### BACKGROUND

In DE 10 2017 125 796 A1, a fastening system for fastening in a receptacle of a carrier component is disclosed. This fastening system comprises a fastening element having a guide portion that can be inserted into the receptacle along an insertion direction, and a clip element stuck onto the guide portion, comprising holding edges cooperating with an inner surface of the receptacle for holding the fastening element and the clip element in the receptacle, wherein the guide portion and the clip element comprise cooperating latching portions, via which the clip element is held in a latching matter on the guide portion, and wherein the latching portions are configured such that an axial tensile force for releasing the fastening element and the clip element from the receptacle causes a force acting radially outward on the holding edges of the clipping element.

DE 10 2019 134 582 A1 discloses a bolt receptacle for fastening to a bolt. This bolt receptacle comprises a base body having a passage opening extending in an assembly direction for receiving a bolt. The bolt receptacle is characterized in that at least three latching arms are provided, wherein the latching arms are arranged radially circumferentially and unevenly spaced apart from one another around the passage opening, and wherein the latching arms each comprise at least one latching lug for fixing the bolt receptacle to a bolt in a latching member.

### SUMMARY

The problem addressed by the present invention is to provide a fastening apparatus for fastening a component to a bolt of a carrier component, which offers an alternative to fastening apparatuses known from the prior art.

A further problem addressed by the present invention is to provide a fastening apparatus that is flexible in its application and can be fixed to different types of bolts.

In addition, a problem addressed by the present invention is to form a fastening apparatus for fastening a component to a carrier component that is simply constructed and safe and reliable to use.

According to the invention, a fastening apparatus is provided for fastening a component to a bolt of a carrier component. This fastening apparatus comprises a housing device having a receiving space for receiving a bolt in an axial direction and a fastening clip arranged in the receiving space of the housing device, wherein the fastening clip comprises at least two, preferably spring-like latching arms, at whose free ends preferably linear latching edges are formed so as to hold a bolt, wherein the latching edges of the latching arms are inclined relative to the axial direction.

Bolt fastening systems can usually be used only in conjunction with a particular bolt surface. Bolt fastening systems are therefore configured either for threaded bolts or bolts having a smooth sheath wall. In addition, bolts having undercuts for correspondingly configured fastening systems are also known.

According to the present invention, a fastening apparatus or an assembly is now provided for the first time, consisting of a housing device and a fastening clip, which is characterized in that at least two spring-like latching arms are provided, at whose free ends latching edges are integrally formed for holding a bolt, wherein the latching edges of the latching arms are linearly formed and inclined relative to the axial direction. This means that the latching edges increase or decrease radially circumferential or tangentially, such that the latching edges of the latching arms have a predetermined slope that is radially circumferential or tangential to a bolt to be received or to an axial axis, respectively.

Due to the corresponding incline of the latching edges relative to the axial direction, the apparatus is suitable for threaded bolts as well as for bolts having smooth sheath walls.

In the case of a bolt with a smooth sheath wall, the latching edges of the latching arms latch on or in the surface of the bolt. By contrast, in the case of a threaded bolt, the latching edges of the latching arms are caught between the corresponding threads, because the latching edges, similar to the slope of a thread, are inclined relative to the axial direction or an axial axis of the receiving space.

The latching edges can thus have a slope that approximately or precisely corresponds to the slope of a thread of a threaded bolt.

In this manner, a flexible fastening apparatus is provided, which is suitable for different types of bolts and thus for both threaded bolts and for bolts having a smooth sheath wall.

The fastening clip is preferably formed from a metal, wherein the housing device is preferably formed from a plastic.

The fastening clip is configured or shaped such that the fastening apparatus can be easily disassembled from a bolt by unscrewing.

Thus, a fastening apparatus is provided for the first time which can be assembled onto a bolt in an axial direction and can simultaneously be easily removed from a bolt by unscrewing.

A direction parallel to the axial direction of a bolt or parallel to an axial direction of the fastening apparatus in which the fastening apparatus can be assembled onto a bolt of a carrier component is also referred to hereinafter as the assembly direction.

The latching edges of the latching arms can be inclined orthogonally to the axial direction in two different directions, in an X and a Y direction, respectively.

This means that the linear latching edges are not only inclined relative to a longitudinal direction such that the latching edges run parallel to the X/Y plane, but rather are inclined corresponding to the slope of a thread relative to the X/Y plane in an X and a Y direction.

Thus, the latching edges are preferably inclined tangentially to the axial direction or to an axial axis of the receiving space at a predetermined angle, respectively.

As already shown above, by providing such linear latching edges inclined in the X and Y directions, it is possible to arrange and disassemble components on bolts having a smooth surface as well as on threaded bolts by means of the fastening apparatus.

The component to be fastened can be, for example, holding elements such as cable holders or fastening elements or trim parts or covers or the like.

Due to the slope of the latching edges relative to the axial direction and/or the X/Y plane, the latching arms can be configured such that the fastening apparatus can be assembled on a bolt by a preferably linear movement in the axial direction and can be disassembled by a rotational movement about a longitudinal axis of a bolt extending in the axial direction.

The arms are inclined at a predetermined angle relative to the axial direction and in particular counter to the assembly direction. That is to say, the latching arms extend from free ends of the fastening clip in the direction of a top wall of the housing device. A corresponding inclination angle is at least 15° or at least 20° or at least 25° or at least 40° or at least 45°, and at most 50° or 55° or 60° or 65° or 75°.

The housing device can comprise a base wall having a bolt passage opening for introducing a bolt into the receiving space, two side wall portions that are diametrically opposed to one another, and a top wall. The base wall is connected to the top wall via the two side wall portions. Portions of the side wall portions facing the receiving space, which are referred to as stop portions, can be configured so as to conically taper in the region of the base wall from the side walls in the direction of the base wall, wherein free ends of the fastening clip on which the latching arms are formed can comprise conically tapering pressure portions in the region of the stop portions.

In a preferably unstressed final assembly position in which the fastening apparatus is caught on a bolt, the pressure portions can be arranged so as to be spaced apart from the respective stop portions, wherein, in a stressed final assembly position, in which the fastening apparatus is tension-stressed, the pressure portions can abut or strike the stop portions, so that the pressure portions of the fastening clip, due to the conically tapering design of the stop portions and the pressure portions, act on the latching edges of the latching arms with a pressure force acting in the radial direction inwards in the direction of the receiving space and thus in the direction of a bolt.

In this manner, due to the striking of the pressure portions of the fastening clip against the stop portions of the housing device, the latching edges of the latching arms are subjected to a force acting in the direction of a bolt arranged in the receiving space as soon as the bolt is tension-stressed. In the unstressed state, the pressure portions are arranged so as to be spaced apart from the stop portions.

Thus, in the stressed final assembly position, a bolt arranged in the receiving space can thereby be subjected to a higher compressive force compared to the unstressed final assembly position in order to significantly increase the holding force.

At the portions of the side wall portions facing the receiving space and arranged adjacent to the stop portions, anti-rotation portions can be formed, having anti-rotation elements facing in the direction of the receiving space, wherein the fastening clip comprises anti-rotation recesses in this region, in which the anti-rotation portions are received, such that the fastening clip is received in the receiving space of the housing device in a rotation-proof manner.

Due to the fact that the fastening clip is received in the housing device in a rotation-proof manner via the anti-rotation portions and the anti-rotation elements, the fastening apparatus or the parts connected thereto can be easily unscrewed from a bolt of a carrier component.

Thus, the apparatus according to the invention is also configured for repeated use or for repeated assembly of a component and corresponding disassembly of a component.

Insertion elements that conically taper in the direction of the receiving space can be formed on the base wall in order to subject the fastening clip to a bias, so that it can be arranged in the receiving space in an assembly position.

The insertion elements significantly simplify the assembly of the fastening apparatus according to the invention and/or an introduction of the fastening clip into the receiving space of the housing device.

When the fastening clip is introduced, the free ends of the fastening clip slide along the conically tapering insertion elements, whereby the fastening clip is compressed. When the fastening clip is introduced into the receiving space of the housing device, the clip is thus compressed when it is subjected to a compressive force running orthogonally to the axial direction. In this way, the anti-rotation elements of the housing device can be arranged in the anti-rotation portions of the fastening clip in order to arrange the fastening clip securely, reliably, and easily as well as without great technical effort in an assembly position in which the fastening apparatus can be assembled onto a bolt.

A bolt receptacle extending in the axial direction and configured in portions so as to be tubular can be arranged in the receiving space for guiding and positioning a bolt to be received, wherein the bolt receptacle connects the top wall and the base wall.

Such a bolt receptacle is used for guidance and positioning, and thus for ease of assembly of the fastening apparatus onto a bolt of a carrier component.

The tubularly formed portion of this bolt receptacle preferably has a diameter that is at least one tenth or at least two tenths and at most three tenths to at most four tenths mm larger than a bolt to be received, such that there is corresponding radially circumferential clearance between the tubularly formed portion of the bolt receptacle and a bolt.

The fastening clip can be approximately U-shaped, wherein the tubular portion of the bolt receptacle is connected to the base wall via two axially extending and diametrically opposed struts, and is connected to the top wall via a connecting portion, so that a receiving recess for inserting the fastening clip into the receiving space of the housing device is formed opposite the connecting portion.

In this manner, a transverse leg of the fastening clip, which connects the two free legs of the fastening clip to one another, can be arranged in the receiving space without blocking a lateral insertion of the transverse portion through the bolt receptacle orthogonally to the axial direction.

Furthermore, according to the present invention, a system with a fastening apparatus described above and a corresponding bolt of a carrier component is provided. The bolt can comprise a planar sheath wall. Alternatively, it can also be a corresponding threaded bolt.

The advantages of the system according to the present invention are analogous to the advantages discussed above on the basis of the fastening apparatus.

In addition, according to the present invention, a method for assembling a fastening apparatus according to the present invention is provided. It includes the following steps:

moving a fastening clip orthogonally to an axial direction in the direction of a receiving space of a housing device,

compressing free ends of the fastening clip by means of corresponding, conically tapering insertion elements and thereby subjecting the free legs of the fastening clip to a bias,

further sliding of the fastening clip in a direction orthogonal to the axial direction,

arranging anti-rotation portions of the housing device in corresponding anti-rotation recesses of the fastening clip and thereby arranging the fastening clip in the receiving space of the housing device in a rotation-proof manner.

### BRIEF DESCRIPTION OF THE DRAWINGS

The fastening apparatus according to the invention will now be described in further detail on the basis of an exemplary embodiment shown in the figures:

FIG. 1 is a perspective view of a fastening apparatus according to the invention,

FIG. 2 is a further perspective view of the fastening apparatus according to the invention,

FIG. 3 is a side view of the fastening apparatus in which a fastening clip is inserted into a housing device of the fastening apparatus,

FIG. 4 is a side view of the fastening apparatus in an assembly position, in which the fastening clip is arranged completely in the receiving space of the housing device of the fastening apparatus,

FIG. 5 is a side view of the fastening apparatus in a final assembly position in a tension-stressed state and in a state of being arranged on a bolt,

FIG. 6 is a further side view of the fastening apparatus without the fastening clip,

FIG. 7 is a perspective view of the fastening apparatus without the fastening clip,

FIG. 8 is a plan view from below onto a base wall having a passage opening for receiving a bolt,

FIG. 9 is a side view of the fastening apparatus,

FIG. 10 is a further side view of the fastening clip,

FIG. 11 is a further side view of the fastening clip, and

FIG. 12 is a plan view from above onto a top wall of the fastening clip.

### DETAILED DESCRIPTION

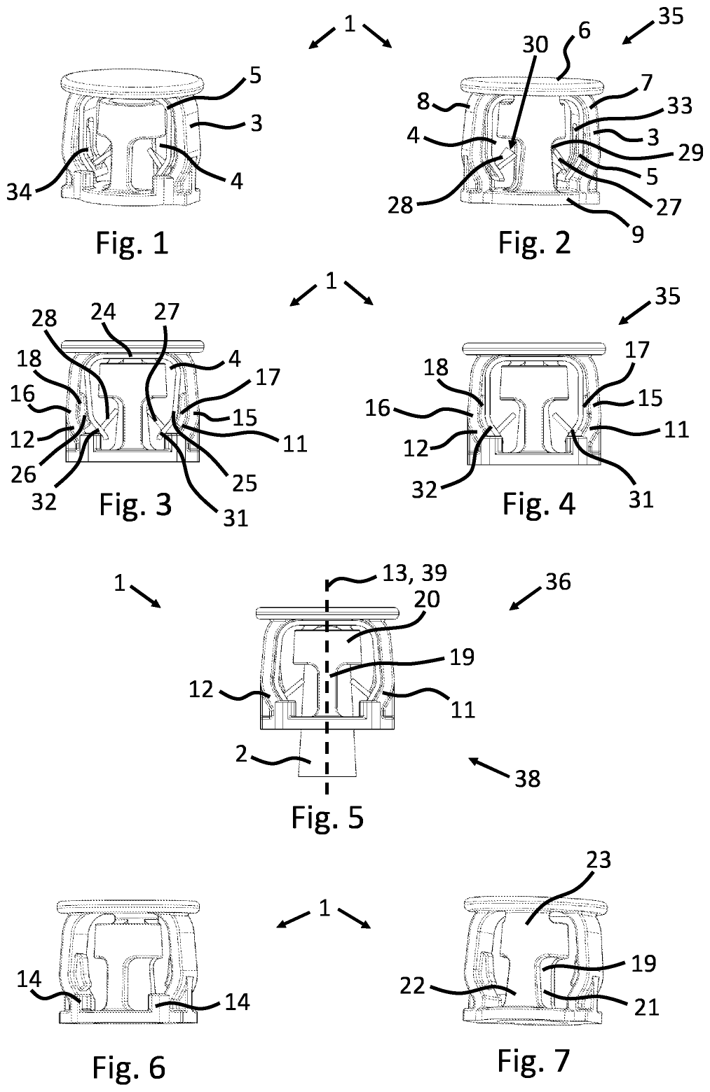

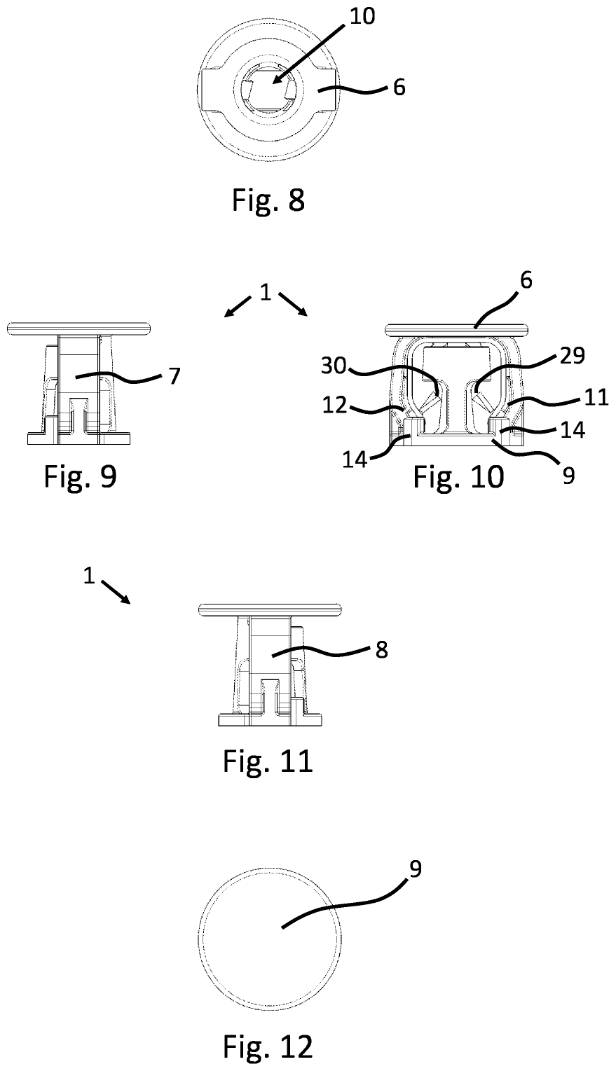

A fastening apparatus 1 for fastening a component (not shown) to a bolt 2 of a carrier component (not shown) is described in further detail below on the basis of an exemplary embodiment (FIGS. 1-12).

Such an assembly or fastening apparatus 1 comprises a base body or a housing device 3 and a fastening clip 5 arranged in a receiving space 4 of the housing device 3.

The housing device 3 is manufactured by means of a single-component injection molding process and is thus formed from a plastic. The fastening clip 5 is manufactured and formed from a metal, for example a spring steel.

The housing device 3 comprises a circular disk-shaped top wall 6, side wall portions 7, 8, via which the top wall 6 is connected to a base wall 9.

The side wall portions 7, 8 are approximately C-shaped in a lateral view.

In the base wall 9, a bolt passage opening 10 is formed for introducing a bolt 2 into the receiving space 4 of the housing device 3.

In the region of the base wall 9, portions of the side wall portions 7, 8 facing the receiving space 4 form stop portions 11, 12. The stop portions 11, 12 are configured in the region of the base wall so as to conically taper from the side wall portions 7, 8 in the direction of the base wall 9.

Furthermore, in this region, insertion elements 14 which extend orthogonally to an axial direction 13 and conically taper in this direction are formed on the base wall.

Furthermore, anti-rotation portions 15, 16 are formed on the portions of the side wall portions facing the receiving space. In the region of the anti-rotation portions 15, 16, anti-rotation elements 17, 18 extending in the direction of the receiving space 4 and facing the receiving space 4 are integrally formed.

A bolt receptacle 19 extending in the axial direction 13 is arranged in the receiving space 4. The bolt receptacle 19 comprises a tubular guide portion 20, which is connected to the base wall 9 via two struts 21, 22.

In a region diametrically opposite the insertion elements 14, the tubular guide portion 20 is connected to the top wall 6 via a connecting portion 23.

The fastening clip 5 is U-shaped and thus has a transverse leg 24 connecting two free legs 25, 26 to one another.

At free ends of the legs 25, 26, latching arms 27, 28 are formed. Linear latching edges 29, 30 are formed on the latching arms 27, 28.

The latching edges 29, 30 are inclined relative to the axial direction 13 similarly to the slope of a thread. Thus, the latching edges 29, 30 are inclined orthogonally to the axial direction 13 relative to an X/Y plane in both an X direction and a Y direction.

This means that the latching edges 29, 30 increase or decrease radially circumferential or tangentially, such that the latching edges 29, 30 of the latching arms 27, 28 have a predetermined slope that is radially circumferential or tangential to a bolt to be received or to an axial axis 39 of the receiving space 4, respectively.

The latching edges 29, 30 of the latching arms 27, 28 are thus inclined orthogonally to the axial direction 13 and to the axial axis 39 in two different directions, in an X and a Y direction, respectively.

This means that the linear latching edges 27, 28 are not only inclined relative to the axial direction 13 such that the latching edges 27, 28 run parallel to the X/Y plane, but rather are inclined corresponding to the slope of a thread relative to the X/Y plane in an X and a Y direction.

Thus, the latching edges 27, 28 are preferably inclined tangentially to the axial direction 13 or to the axial axis 39 at a predetermined angle, respectively.

Pressure portions 31, 32 are formed at the free ends of the legs 25, 26, on which the latching arms 27, 28 are arranged. In the region of the pressure portions 31, 32, the free ends of the fastening clip 5 are configured so as to be conically tapering in the direction of the receiving space.

Adjacent to the pressure portions 31, 32, anti-rotation recesses 33, 34 are recessed from the material of the fastening clip 5.

In an assembly position 35 in which the fastening apparatus 1 is in a starting state for assembling a component onto a bolt 2 of a carrier component, the pressure portions 31, 32 of the fastening clip 5 are arranged so as to be spaced apart from the stop portions 11, 12 of the housing device 3.

The anti-rotation elements 17, 18 of the anti-rotation portions 15, 16 of the housing device 3 are received in the anti-rotation recesses 33, 34 of the fastening clip 5 so that the fastening clip 5 is arranged in the receiving space 4 of the housing device 3 in a rotation-proof manner (FIG. 4).

The two legs 25, 26 are arranged in the region of the side wall portions 7, 8 and the transverse leg 24 is arranged in the region of the top wall 6 parallel thereto and in a free space between the tubular guide portion 20 and the connection portion 23.

In an unstressed final assembly position 37 (not shown), in which the fastening apparatus is caught on a bolt, the pressure portions are arranged so as to be spaced apart from the respective stop portions.

In a stressed final assembly position 38 (FIG. 5) in which the fastening apparatus is tension-stressed, the pressure portions abut the stop portions, so that the pressure portions of the fastening clip, due to the conically tapering design of the stop portions and the pressure portions, act on the latching edges of the latching arms with a pressure force acting in the radial direction inwards in the direction of the receiving space and thus in the direction of a bolt.

In this manner, due to the striking of the pressure portions of the fastening clip against the stop portions of the housing device, the latching edges of the latching arms are subjected to a force acting in the direction of a bolt arranged in the receiving space as soon as the bolt is tension-stressed. In the unstressed state, the pressure portions are arranged so as to be spaced apart from the stop portions.

Thus, in the stressed final assembly position, a bolt arranged in the receiving space can thereby be subjected to a higher compressive force compared to the unstressed final assembly position in order to significantly increase the holding force.

Furthermore, according to the present invention, a system 36 comprising the fastening apparatus 1 as well as a bolt 2 of a carrier component is provided.

In addition, according to the present invention, a method for assembling a fastening apparatus according to the present invention is provided. It includes the following steps:

moving a fastening clip orthogonally to an axial direction in the direction of a receiving space of a housing device,

compressing free ends of the fastening clip by means of corresponding, conically tapering insertion elements and thereby subjecting the free legs of the fastening clip to a bias,

further sliding of the fastening clip in a direction orthogonal to the axial direction,

arranging anti-rotation portions of the housing device in corresponding anti-rotation recesses of the fastening clip and thereby arranging the fastening clip in the receiving space of the housing device in a rotation-proof manner.

### LIST OF REFERENCE NUMERAL

1 Fastening apparatus
2 Bolt
3 Housing device
4 Receiving space
5 Fastening clip
6 Ceiling wall
7 Side wall portion
8 Side wall portion
9 Base wall
10 Bolt passage opening
11 Stop portion
12 Stop portion
13 Axial direction
14 Insertion elements
15 Anti-rotation portion
16 Anti-rotation portion
17 Anti-rotation element
18 Anti-rotation element
19 Bolt receptacle
20 Tubular guide portion
21 Strut
22 Strut
23 Connecting portion
24 Transverse leg
25 Leg
26 Leg
27 Latching arm
28 Latching arm
29 Latching edge
30 Latching edge
31 Pressure portion
32 Pressure portion
33 Anti-rotation recess
34 Anti-rotation recess
35 Assembly position
36 System
37 Final assembly position (unstressed state)
38 Final assembly position (stressed state)
39 Axial axis

1. A fastening apparatus for fastening a component to a bolt of a carrier component, comprising:
a housing device having a receiving space for receiving a bolt in an axial direction, and
a fastening clip arranged in the receiving space of the housing device, wherein the fastening clip comprises at least two latching arms, at whose free ends latching edges are formed so as to hold a bolt, wherein the latching edges of the latching arms are inclined relative to the axial direction.

2. The fastening apparatus according to claim 1,
wherein
the latching edges of the latching arms are linearly formed and inclined orthogonally to the axial direction relative to an X/Y plane in two different directions, respectively, such that the latching edges of the latching arms have a predetermined slope that is radially circumferential or tangential, to a bolt to be received and thus to an axial axis of the receiving space.

3. The fastening apparatus according to claim 1,
wherein
due to the slope of the latching edges relative to the axial direction and/or the X/Y plane, the latching arms are configured such that the fastening apparatus can be assembled on a bolt by a movement in the axial direction and can be disassembled by a rotational movement about a longitudinal axis of a bolt extending in the axial direction.

4. The fastening apparatus according to claim 1,
wherein
the housing device comprises a base wall having a bolt passage opening for introducing a bolt into the receiving space, two diametrically opposed side wall portions, and a top wall, wherein the base wall is connected to the top wall via the two side wall portions, and wherein portions of the side wall portions facing the receiving space, which are referred to as stop portions, are configured in the region of the base wall so as to be conically tapering from the side walls in the direction of the base wall, wherein free ends of the fastening clip, onto which the latching arms are formed, comprise conically tapering pressure portions in the region of the stop portions.

5. The fastening apparatus according to claim 4,
wherein
in a final assembly position, in which the fastening apparatus is caught on a bolt, the pressure portions are arranged so as to be spaced apart from the respective stop portions, and wherein in a stressed final assembly position, in which the fastening apparatus is tension-stressed, the pressure portions abut the stop portions, so that the pressure portions of the fastening clip, due to the conically tapering design of the stop portions and the pressure portions, act on the latching edges of the latching arms with a pressure force acting in the radial direction inwards in the direction of the receiving space and thus in the direction of a bolt.

6. The fastening apparatus according to claim 4,
wherein
at the portions of the side wall portions facing the receiving space and arranged adjacent to the stop portions, anti-rotation portions are formed, having anti-rotation elements facing in the direction of the receiving space, wherein the fastening clip comprises anti-rotation recesses in this region, in which the anti-rotation portions are received, such that the fastening clip is received in the receiving space of the housing device in a rotation-proof manner.

7. The fastening apparatus according to claim 1,
wherein
insertion elements that conically taper in the direction of the receiving space are formed on the base wall in order to subject the fastening clip to a bias, so that it can be arranged in the receiving space in an assembly position.

8. The fastening apparatus according to claim 1,
wherein
a bolt receptacle extending in the axial direction and configured in portions so as to be tubular is arranged in the receiving space for guiding and positioning a bolt to be received, wherein the bolt receptacle connects the top wall and the base wall.

9. A fastening system having a fastening apparatus according to claim 1 and a threaded bolt or a bolt having a planar sheath wall.

10. A method for assembling a fastening apparatus, comprising the following steps:
moving a fastening clip orthogonally to an axial direction in the direction of a receiving space of a housing device,
compressing free ends of the fastening clip by means of corresponding, conically tapering insertion elements and thereby subjecting the free legs of the fastening clip to a bias,
further sliding of the fastening clip in a direction orthogonal to the axial direction,
arranging anti-rotation portions of the housing device in corresponding anti-rotation recesses of the fastening clip and thereby arranging the fastening clip in the receiving space of the housing device in a rotation-proof manner.
